(19) United States
(12) Patent Application Publication
(10) Pub. No.: US 2015/0207226 A1
(43) Pub. Date: Jul. 23, 2015

(54) Broadband Electromagnetic Radiators and Antennas

(71) Applicant: Andrew Stan Podgorski, Ottawa (CA)

(72) Inventor: Andrew Stan Podgorski, Ottawa (CA)

(21) Appl. No.: 14/161,561

(22) Filed: Jan. 22, 2014

(51) Int. Cl. H01Q 3/26

(52) U.S. Cl. CPC H01Q 3/26

(57) ABSTRACT

This invention allows combining broadband GW (10⁺⁹ Watt) peak power to achieve MV/m (10⁺⁶ Volt/meter), and GV/m (10⁺⁹ Volt/meter), radiated E-fields of air or vacuum breakdown across the entire electromagnetic spectrum, including optical frequencies. Use of multiple antennas and independently triggered generators allows achieving GV/m fields, while by preventing the E-field induced breakdown it provides control of power and energy content at targets. The achieved broadband MV/m E-field levels and energy density significantly exceed levels required for destruction of distant electronic targets; therefore, this invention radically improves the effectiveness of electromagnetic weapons. Furthermore, collimating multiple MV/m beams allows reaching GV/m E-fields that exceed by orders of magnitude the air or vacuum breakdown needed for broadband plasma excitation at resonance plasma frequencies in the 300 GHz range, permitting energy-efficient plasma research leading to fusion.

### BACKGROUND OF THE INVENTION

1. Field of the Invention

The present invention enables combining broadband GW peak power to achieve MV/m and GV/m radiated electromagnetic fields of air or vacuum breakdown across the entire electromagnetic spectrum, including optical frequencies. The invention applies to broadband electromagnetic radiating systems, operating in transmitting and/or receiving modes.

More particularly, the invention relates to radiating systems generating the MV/m E-field that can be used as an ultimate microwave weapon facilitating the destruction of electronic systems at distances that at 1 GHz correspond to 10's of kilometres. Furthermore, the broadband character of this invention provides the maximum coupling of electromagnetic power and energy to target and the ultimate power density assures the highest probability of target destruction. The GV/m radiating systems operating in the 300 GHz frequency range, by reaching power density exceeding breakdown i.e. ionization, allow broadband excitation at resonance plasma frequencies permitting molecular, atomic and fusion research. In the receiving mode, the radiated power from single or multiple points/transmitters is received in a collimated beam/beams and is directed simultaneously to multiple spatially-dispersed broadband antennas and receivers allowing multichannel independent time and frequency data processing.

2. Description of the Related Art

Use of narrowband coherent (i.e. identical frequency and phase) power combined at specific frequencies (U.S. Pat. No. 7,800,538 B2 to Crouch et al.) intended to destroy distant targets vulnerable at unknown frequencies resulted in unspecified coupling of the electromagnetic energy to the target undermining the effectiveness and usefulness of the electromagnetic weapons. These designs use multiple, narrowband, relatively low power (MW instead of GW) generators operating simultaneously at different frequencies, and low gain antennas that suffer significant beam dispersion (U.S. Pat. No. 7,126,530 B2 to Brown). These factors limit the power density and E-field that can be delivered to distant targets resulting in a low probability of target destruction.

As per Reference 1, a broadband radiating system that uses a single GW generator and low-gain TEM-mode antenna illuminating a reflector has a limited weapons range since there is no possibility of adding more generators and antennas to increase the radiated E-field.

An effort (U.S. Pat. No. 8,576,109 B2 to Stark et al.) to create higher E-fields, by adding to the surface of the reflector of Reference 1, non-linear semiconductor switches to increase power allows generation of E-fields limited by low withstand voltage tolerance of the semiconductor devices. Since the E-field at the antenna reflector is limited to prevent damage to the semiconductor switches, the radiated E-field intensity precludes destruction of the semiconductor devices of a distant target.

Reference 1. Carl E. Baum et al., “JOLT: A Highly Directive, Very Intensive Impulse-Like Radiator”, Report of ITT Industries for US Air Force Research Lab., AFRL-DE-PS-TR-2006-1073, 2006.

### SUMMARY OF THE INVENTION

This invention, by using many separate and independently triggered generators and spatially and angularly positioned high power antennas that allow adding individual pulses and beams to deliver to the target the maximum power density limited only by the E-field of air or vacuum breakdown. Operation very close to the E-field breakdown level, optimization of each generator triggering time and selection of pulse frequency spectral content, allow achieving ultimate peak power and energy transfer to the target. Delivery of broadband frequency spectral content that induces an oscillating response at specific resonance frequencies in the target further improves the energy transfer. In response to a short pulse, with duration defined by the minimum frequency of the bandwidth, the induced resonances will prolong the effects of excitation for a period proportional to the oscillation quality factor. Since the oscillation quality factor, for example for cable coupling in electronic equipment is in the range 5 to 10, the effect of single pulse excitation can be prolonged up to 10 times, reducing the number of required excitation pulses, therefore reducing the energy requirements from generators. This invention addresses only a few applications in 1 to 500 GHz frequency range, but the power addition applies to the entire electromagnetic spectrum from GHz, including optical frequencies as it assures that the power density and therefore the E-field on target does not decrease with frequency. The power density remains almost constant, as it is proportional to the radiated power that is decreasing with frequency divided by the illumination area on target that as well is decreasing with frequency. This invention allows selecting the frequency range of operation and by means of geometrical scaling assembling systems that could be used for a variety of purposes: plasma physics leading to fusion, fusion propulsion, particle accelerators, material deposition, medical interventions at molecular and atomic levels, quantum computing, nonlinear electromagnetics, electromagnetic and particle missiles, electromagnetic weapons and in other areas relaying on high power electromagnetic interactions.

### BRIEF DESCRIPTION OF THE DRAWINGS

FIG. 1A is a 3D view of “on-the-axis” Cassegrain antenna of the present invention, for the illumination of targets at long-range distances.

FIG. 1B is a 3D view and ray tracing in “on-the-axis” Cassegrain antenna of the present invention.

FIG. 1C is a 2D view of ray tracing in “on-the-axis” Cassegrain antenna of the present invention.

FIG. 2A is a 3D view of “on-the-axis” Cassegrain antenna with a Barlow lens system of the present invention, for illumination of targets at long-range distances.

FIG. 2B is a 3D view and ray tracing in “on-the-axis” Cassegrain antenna with a Barlow lens system of the present invention.

FIG. 2C is a 2D view of ray tracing in “on-the-axis” Cassegrain antenna with a Barlow lens system of the present invention.

FIG. 3 is a 3D view and ray-tracing showing focusing a parallel beam coming from “on-the-axis” Cassegrain antenna of FIG. 1 or 2. This embodiment allows illumination of targets located at distances of few beam-diameters away from the focusing lens, assuring the smallest possible diameter of the focusing point.

FIG. 4A is a view of the concave-face broadband antenna array consisting of broadband single-polarization TEM-horns with each adjacent antenna having different polarization.

FIG. 4B is a view of the convex-face broadband antenna array consisting of broadband single-polarization TEM-horns.

FIG. 4C is a view of the flat-face broadband antenna array consisting of broadband single-polarization TEM-horns.

FIG. 5A is a cutout view of the broadband single-polarization TEM-horns.

FIG. 5B is a cutout view of the dielectric-loaded single-polarization broadband TEM-horns with coaxial and strip-line input connections.

FIG. 6 is a 2D and cutout view of the broadband conical double-polarization TEM-horns with coaxial and strip-line input connections.

FIG. 7 is a 2D and cutout view of the broadband conical double-polarization TEM-horns of FIG. 6 of the present invention, with coaxial and strip-line input connections and conical enclosure bisected.

FIG. 8 is a 2D view of the broadband conical double-polarization TEM-horns of FIG. 6 or 7 of the present invention, loaded with dielectric material and having coaxial and strip-line input connections.

### DETAILED DESCRIPTION OF THE INVENTION

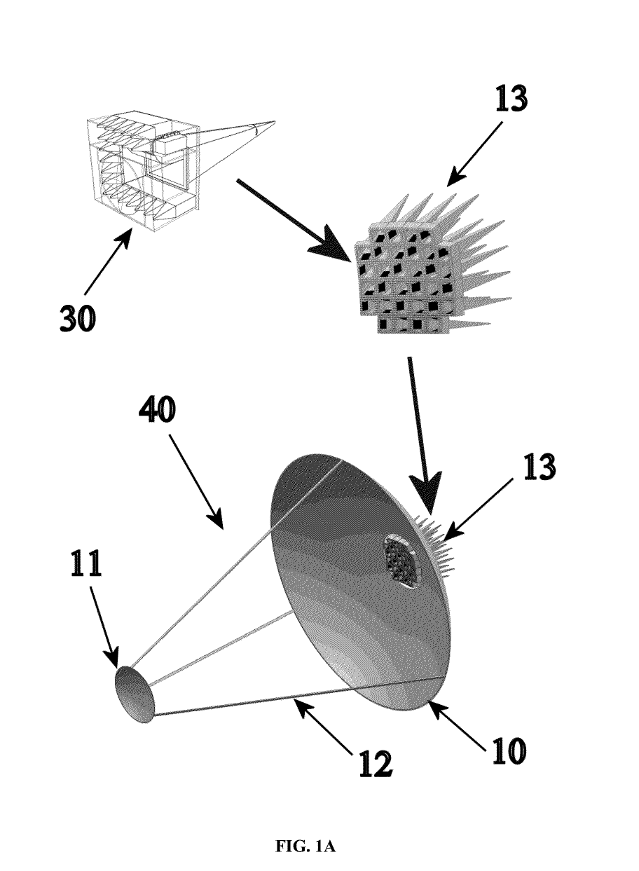

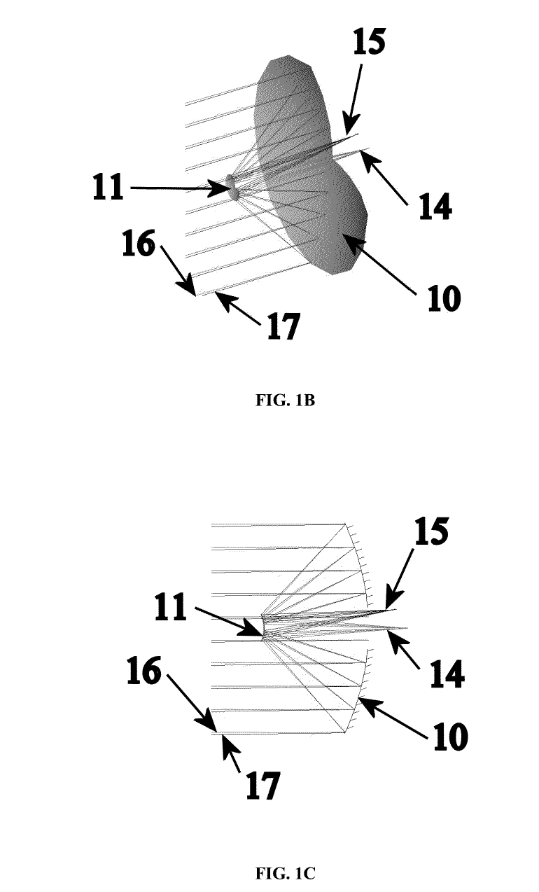

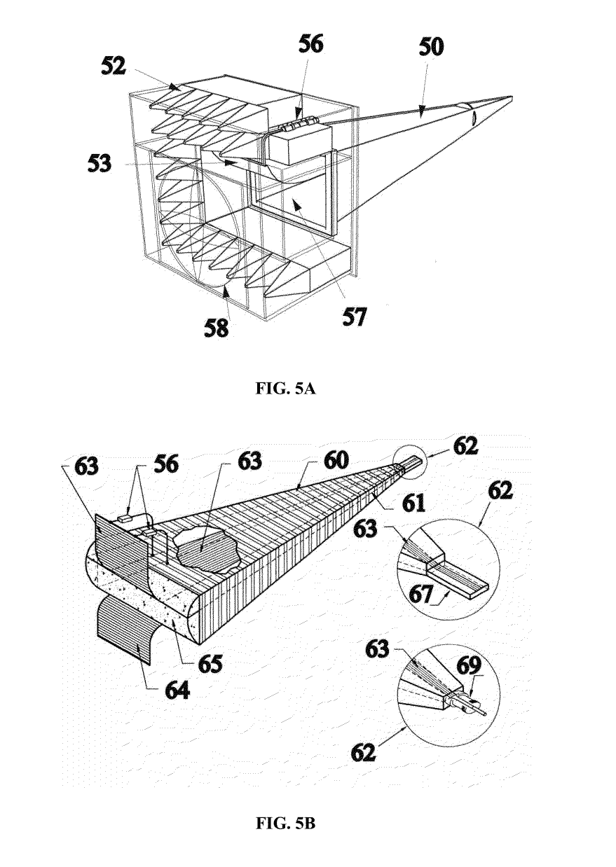

This invention relates to broadband electromagnetic radiating systems, operating in a transmitting and/or receiving mode in the entire electromagnetic spectrum, including optical frequencies, at power levels up to or exceeding ionization. In the transmitting mode, the present invention allows combining broadband GW peak power to achieve MV/m and GV/m radiated E-fields of air or vacuum breakdown. In the receiving mode, the radiated power from a single or multiple points/transmitters is received in a collimated beam/beams and it is directed simultaneously through multiple spatially dispersed broadband antennas and receivers allowing multichannel independent time and frequency data processing at large distances. Considering the reciprocity principle in electromagnetics, only the transmitting mode operation is described in this submission. However, it should be understood that reversing the direction of signal propagation and replacing generators with receivers allows changing between transmitting and receiving mode of operation. The overall view of FIG. 1A, B and C, show 3D physical, 3D beams and 2D beams, of focused at infinity “on-the-axis” Cassegrain antennas 40, for the illumination of targets at long range distances. The Cassegrain antenna 40 consists of a primary reflector 10, a secondary reflector 11, three support arms 12 and antenna array 13. The antenna array 13 is assembled with 32 vertically and horizontally polarized broadband individual TEM-horns 30 described in detail in FIG. 5A.

The Cassegrain antenna 40 is converting diverging conical beams 14 and 15 coming from a focal point from each illuminating TEM-horn, after being reflected from the secondary reflector 11 and primary reflector 10, to non-diverging beams 16 and 17 that illuminate the entire target. Considering that, the radiated power from a single illuminating antenna 30 is limited to GW range, to achieve the MV/m E-field multiple illuminating antennas need to be used. This results in beam 15 originating from antennas furthest from the reflector axis being skewed 17, i.e. the beam 17 diverges from the main beam 16. Therefore, to prevent beam skewing it is desired to use a reflector antenna with the largest angular amplification, i.e. largest ratio of the angle between beams 14 and 15 versus angle between beams 16 and 17. Currently the only antenna with the largest angular amplification and no focal point in the radiating path is a Cassegrain antenna and such antenna is used in this invention. To show the effect of beam skewing, FIG. 1B and 1C show two beams one on the axis 14 and second the most distant from the axis 15, coming from the antenna array 13 and directed towards the target after being reflected from the secondary 11 and primary 10 reflector. The angle between beams 14 and 15 divided by angle between beams 16 and 17 that represents the beam skew, defines the angular amplification of the Cassegrain antenna. Assuming 50% efficiency of each TEM-horn, the maximum radiated peak power delivered by the embodiment of this invention is in the TW (10⁺¹² watt) range in the 1 to 10 GHz band, 100's of GW in the 10 to 100 GHz band and 10's of GW in the 100 to 500 GHz band.

In spite of diminishing power in function of frequency, the invention assures constant power density and therefore constant E-field on target in the entire electromagnetic spectrum including optics. The method of this invention is applicable in the frequency range above 500 GHz even if the broadband TEM-horns are replaced using different antenna concepts. Moreover, progress in high power generation and antenna technology can only improve the peak-power density delivered to targets. One skilled in the art will understand that all broadband radiating systems and antennas of this invention can also operate in the narrowband mode. Furthermore, the invention could be used as broadband and narrowband multi-beam receivers and for wireless combining and dispersing information and control without switching.

In broadband high power radiating systems the power density along the path from the generator to the target that may result in breakdown of the E-field, is a restraining factor in achieving the maximum radiated E-field. In this invention, to assure uniform power density along the path from individual generators to the target the power is added in stages. The first stage consists of multiple individual antennas 30 that can either be powered by one or multiple generators. In the second stage, the conical beams from each antenna in the array 13 are added by directing them into a centre point of the secondary reflector 11. The secondary reflector directs the diverging beams from all antennas into the primary reflector 10. The primary reflector converts all diverging beams into a non-diverging beam directed to the target. In this submission, the simpler-to-visualize and to design on-the-axis Cassegrain antenna is used. However, one skilled in the art will understand that all embodiments of this submission include off-the-axis Cassegrain type antenna arrays. When implementing this embodiment, the effects of beam dispersion and beam skew on power density at the target are to be considered. Since only beams from antennas located on the axis of the array are not skewed, for balanced design of the Cassegrain antenna the number of antennas in the array has to be limited and/or the angular amplification of the Cassegrain antenna has to be increased.

For the best performance of the Cassegrain-antenna that has angular amplification of approximately 10, the power density and the distance from the antenna to the target have to be optimized. At the maximum distance, i.e. at the end of the non-diverging beam region, the target and antenna diameter are equal Dₜ=Dₐ=D, and the maximum number of antennas Nₒₚₜ is defined by the diameter of the primary reflector

$${D}_{λ} \approx \frac{115}{\sqrt{π}} ,$$

expressed in wavelength A corresponding to the “central” frequency of the band.

$${N}_{opt} \frac{π}{350} {D}_{λ}^{2}$$

The maximum target distance R is a function of antenna diameter D_{λ} expressed in wavelength λ.

$${R}_{λ} \leq {R}_{λ opt} \approx \frac{\sqrt{π}}{2} {D}_{λ}^{2}$$

In the narrowband systems operating in the 1 to 5 GHz, the maximum power is lower than 1 GW and the E-field is approximately 75 kV/m for 9 m diameter reflector antenna. For identical frequency range and reflector size, the optimally designed broadband system of this invention, consisting of Cassegrain antenna using 32-antenna array delivers at a distance of Rₒₚₜ=500 m, 2.5 TW power, and E-field of 3 MV/m. Therefore, in comparison to the narrowband system this invention allows reaching the 75 kV/m at a distance up to 30 times greater, while illuminating a target having diameter 30 times larger.

The 9 m reflector diameter expressed in the wavelength as D_{λ}=60 allows, when scaled in the frequency, to cover the entire microwave band up to 500 GHz and as such:
for 10 to 50 GHz band at a distance Rₒₚₜ=60 m, the 1 m diameter antenna delivers 100

GW peak power, and max. E-field of 5 MV/m, 30 J/cm² at 20 kHz pulse repetition frequency,
for 100 to 500 GHz band at a distance Rₒₚₜ=6 m, the 10 cm diameter antenna delivers 3.2 GW peak power, and max. E-field of 9 MV/m, 80 J/cm² at 200 kHz pulse repetition frequency.

For all frequency bands, from 1 to 500 GHz the E-field is close to air breakdown limit and it is approximately 30 times greater than fields currently accepted as electromagnetic threats levels required for the destruction of electronic equipment.

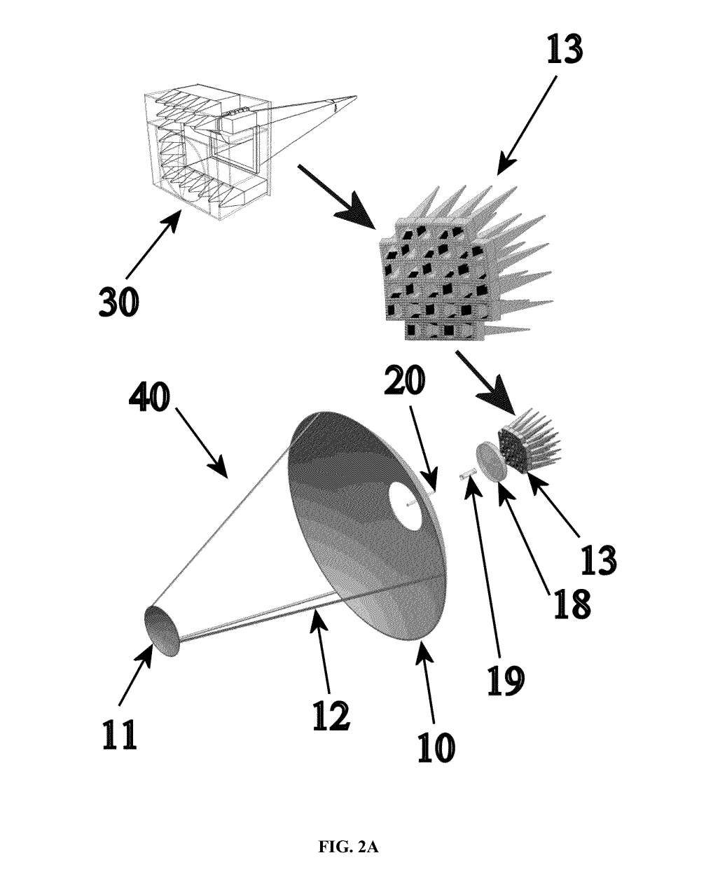

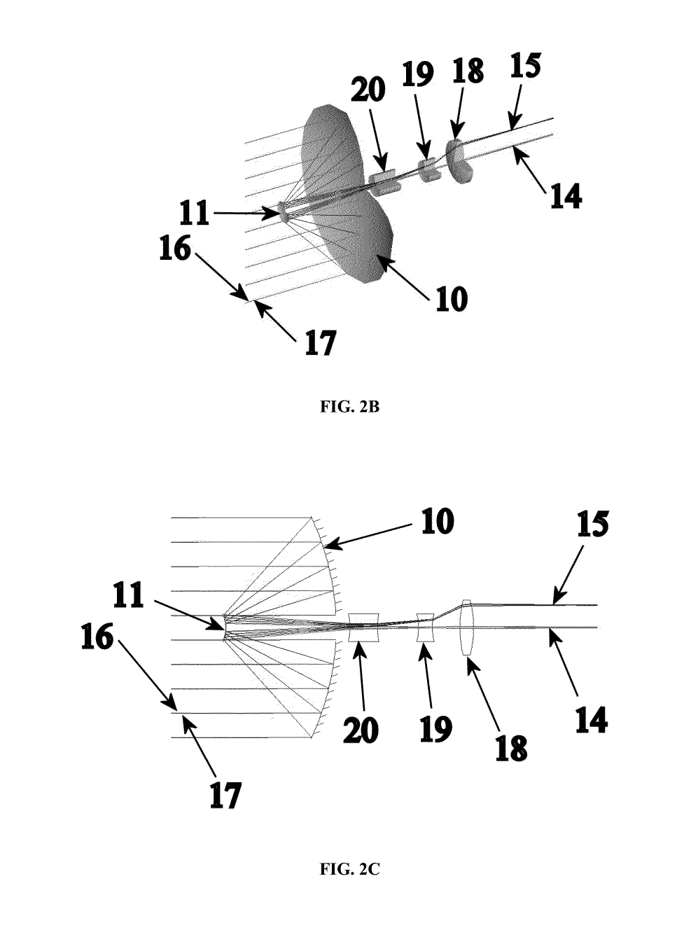

An embodiment of “on-the-axis” Cassegrain antenna focused at infinity with a Barlow lens system is shown in FIGS. 2A, B and C. The Barlow lens system, by increasing the approximate angular amplification of m₀≈10 in Cassegrain antenna allows target illumination at increased distances. The embodiment of FIGS. 2A, B and C was formed by adding the Barlow lens system to the embodiment of FIGS. 1A, B and C. The Barlow lens system that consists of 3 lenses 18, 19 and 20, enables increased illumination range without affecting the power density and E-field. The additional elements of the Cassegrain antenna 40 are the primary reflector 10, the secondary reflector 11, three support arms 12 and antenna array 13.

In the Cassegrain antenna with a Barlow lens system, the on-the-axis beam 14 and the most distant from the axis 15 coming from the antenna array 13 are directed towards the target after passing through the beam collimating Barlow lens system 18, 19 and 20. After being reflected from the secondary reflector 11 and primary 10, the beams are converted to non-diverging beams 16 and 17 that illuminate the entire target. The angle between beams 14 and 15 divided by the angle between beams 16 and 17 that represents the beam skew, defines the angular amplification of the Cassegrain antenna with Barlow lens system m_{B} while m₀ is the angular amplification of the antenna without Barlow lens systems. Since at the maximum distance, i.e. at the end of the non-diverging beam region, the target and antenna diameter are equal Dₜ=Dₐ=D_{B}, the diameter of the Cassegrain antenna primary reflector 10, when expressed in wavelength λ corresponding to the “central” frequency of the band is equal:

$${D}_{B λ} \approx \frac{115}{\sqrt{π}} ( \frac{{m}_{B}}{{m}_{o}} )$$

The maximum number of antennas N_{Bopt} is defined by the diameter D_{Bλ} of the primary reflector 10 and so is the distance R_{BA opt} between the antenna and target:

$${N}_{Bopt} \frac{π}{350} {D}_{B λ}^{2}$$

$${R}_{B λ} \leq {R}_{B λ opt} \approx \frac{\sqrt{π}}{2} {D}_{B λ}^{2}$$

The Cassegrain antenna with Barlow lens system focuses the beam at the third lens 20 into an area inversely proportional to the angular amplification, resulting in an increase of the E-field at that lens. To operate below the breakdown E-field at lens 20, the maximum angular amplification has to be limited.

An example of the effect of using the Barlow lens system follows. The Cassegrain antenna with the angular amplification increased from m₀=10 to m_{b}=15, increases the diameter of the main reflector 10 from D_{λ}=60 λ to D_{Bλ}=97 λ, and increases number of antennas from Nₒₚₜ=32 to N_{Bopt}=85, resulting in an optimum target distance increase from R_{λopt}=3333 λ to R_{Bλopt}=8338 λ. Although the peak E-field at the target remains the same, the addition of the Barlow lens system increases significantly the range and the target illumination area therefore it improves the weapons “kill capability”. Consequently in the entire 1 to 500 GHz frequency range the Cassegrain antenna with Barlow lens system having the main reflector diameter of D_{Bλ}=97 λ, number of antennas of N_{Bopt}=85, and the optimum target distance of R_{BA opt}=8338 λ assures the following:
for 1 to 5 GHz band at a distance of Rₒₚₜ=1250 m, the 14.5 m main reflector diameter antenna delivers 6.8 TW peak power, max. E-field of 3 MV/m, energy density of 10 J/cm² at 2 kHz pulse repetition frequency,
for 10 to 50 GHz band at a distance Rₒₚₜ=125 m, the 1.5 m main reflector diameter antenna delivers 270 GW peak power, max. E-field of 5 MV/m, energy density of 30 J/cm² at 20 kHz pulse repetition frequency,
for 100 to 500 GHz at a distance Rₒₚₜ=12.5 m, the 15 cm main reflector diameter antenna delivers 8.5 GW peak power, max. E-field of 10 MV/m, energy density of 100 J/cm² at 200 kHz pulse repetition frequency.

In the above example, use of the Barlow lens system changed the angular amplification from 10 to 15, increasing the distance to target proportionally to the square of the change in the antenna amplification factor, i.e. increasing the distance

$${( \frac{15}{10} )}^{2} = 2.25$$

times while the maximum E-field remains unchanged. In summary, the E-field is approximately 30 times higher than fields currently accepted as electromagnetic threats causing destruction of electronic equipment. Considering the E-field obtained using this invention and currently accepted threat level in the 1 to 5 GHz band, the electronic systems located as far as 40 km away could be destroyed. Such destruction distance is approximately 100 times greater than distance achieved using current narrowband or broadband systems.

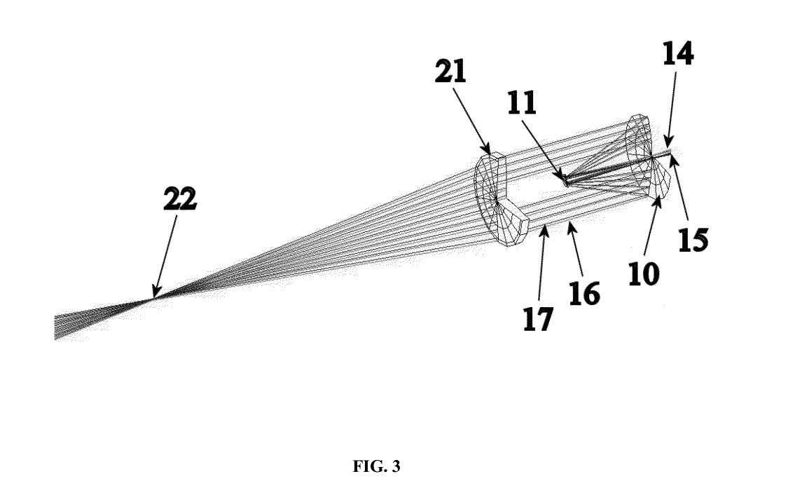

An embodiment of “on-the-axis” Cassegrain antenna focused at infinity, collimating beams at a single point 22 using focusing lens 21 is shown in FIG. 3. In this embodiment, in spite of presence of multiple beams, only two are shown in FIG. 3, one on the axis 14 and second the most distant from the axis 15, that originate from the Cassegrain antenna with or without Barlow lens system, as shown in FIGS. 1A and 2A of this invention. After being reflected from the secondary 11 and primary reflector 10, the beams 16 and 17 are directed towards the focusing lens 21 and are focused at a single point 22. The skew angle represented by the angle between beams 16 and 17 increases the size of the focal point 22, but the effects are too small to be visible in FIG. 3.

Collimating parallel beams radiated by many focusing Cassegrain antennas, into a single point 22 located few beam diameters from the focusing lens 21 allows achieving GV/m E-field that constitutes an enhancement in power addition. Currently, to achieve 0.5 PW peak power required for plasma studies the US National Ignition Facility (NIF) combines 192 laser beams. In this embodiment, after collimating beams coming from 192 Cassegrain antennas having diameter of D_{λ}=60, into a single point the following is achieved.
In 1 to 5 GHz band, in a facility having radius of 30 m the peak power of 0.5 PW and maximum E-field of 0.7 GV/m are achieved at a focal point having diameter of 50 cm. At pulse repetition frequency of 2 kHz, the total energy density of 500 kJ/cm² allows deposition of required for fusion 10⁺⁴ kJ/cm² in 20 sec. and reaching fusion temperature of 1.5*10⁺⁸ K in 80 min.
In 10 to 50 GHz band, in a facility having radius of 3.5 m, peak power of 20 TW and maximum E-filed of 1.4 GV/m are achieved at a focal point having diameter of 5 cm. At pulse repetition frequency of 20 kHz, the total energy density of 2000 kJ/cm² allows deposition of required for fusion 10⁺⁴ kJ/cm² in 5 sec. and reaching fusion temperature of 1.5*10⁺⁸ K in 12 min.
In 100 to 500 GHz band, in the facility having radius of 35 cm, peak power level of 0.6 TW and maximum E-filed of 2.4 GV/m are achieved at a focal point having diameter of 5 mm. At pulse repetition frequency of 200 kHz, the total energy density of 6000 kJ/cm² allows deposition of required for fusion 10⁺⁴ kJ/cm² in 1.7 sec. and reaching fusion temperature of 1.5*10 ⁸ K in 8 sec.

This invention instead of using plasma heating at optical frequencies excites and supports oscillation of fusion plasma in the 300 GHz range therefore assuring more efficient coupling of electromagnetic energy into the plasma. Since the E-field achieved in this embodiment exceeds 100 times the breakdown E-field in vacuum, operation in the 100 to 500 GHz band allows excitation of resonances not only at the fusion plasma frequency of 300 GHz, but also at the 280 GHz fusion plasma cyclotron frequency. Additionally, the broadband excitation that covers numerous frequencies simultaneously allows tracking the change in the resonance frequencies resulting from the changes in plasma density and temperature. Furthermore, increasing frequency of excitation by shortening the pulse duration increases the E-field resulting in larger energy deposition into plasma. Operation in the 100 to 500 GHz band, assures that the diameter of focal point is in the range of 1 to 10 mm and that the 192 Cassegrain antennas occupy volume having small 35 cm radius. Considering that, standard MRI magnets already produce 10 T magnetic fields required for fusion confinement, the entire 192 Cassegrain antenna could be placed within it. Although not shown in FIG. 3, to prevent possible transmission loss in the focusing lens 21, this embodiment could be modified, by replacing the focusing lens 21 with a collimating reflector tilted in respect to the main beam coming from the Cassegrain antenna to focus the beam.

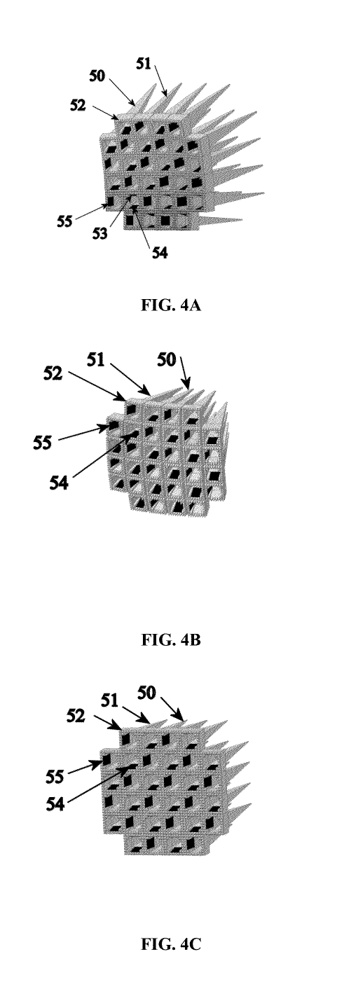

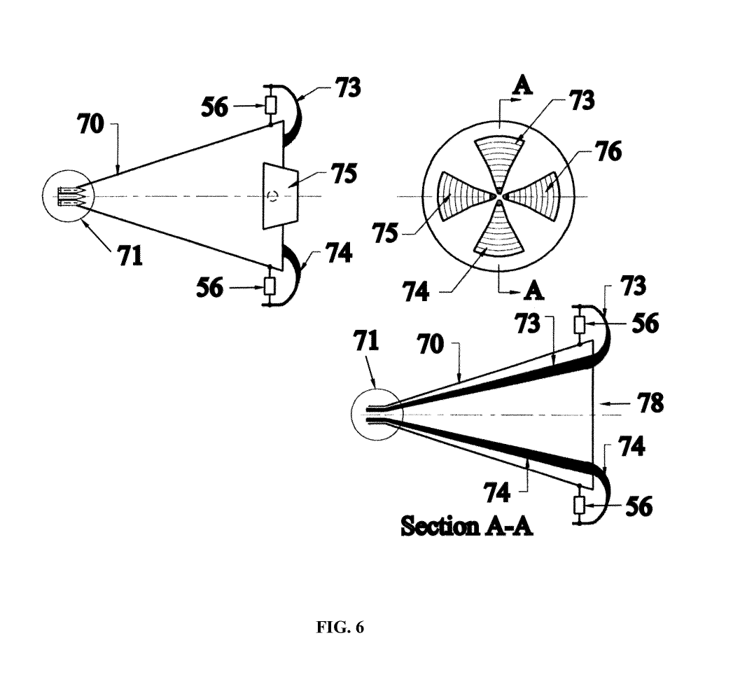

The embodiment of broadband concave, convex and flat face antenna arrays as presented in FIG. 2 of the U.S. Pat. No. 6,295,032 B1 which was issued Sep. 25, 2001 under the title “Broadband horn antennas and electromagnetic field test facility”, and is assigned to the applicant of the present invention is shown in FIGS. 4A, B and C. Considering that the application of the issued Patent was electromagnetic compatibility testing that required one polarization at a time, only individually polarized arrays were addressed in the Patent. In all embodiments of this submission, the array has to radiate E-fields containing both polarizations to assure coupling of the electromagnetic field to targets that are polarization sensitive. To permit radiation of E-field having both polarizations the embodiment of FIGS. 4A, B and C consist of broadband single-polarization TEM-horns with each adjacent antenna having different polarization. Use of double polarization antennas of FIGS. 6, 7 and 8, assures double-polarization operation of the array. In FIGS. 4A, B and C, the antenna 50 is vertically polarized and the antenna 51 is horizontally polarized. All vertically polarized antennas have a forward extending septum 53 and symmetrical to it an antenna enclosure extension 54. In addition, each horizontally polarized antenna has a forward extending septum 55 and (invisible in FIGS. 4A, B, and C), an antenna enclosure extension. To prevent coupling between antennas, the electromagnetic absorbers 52, attenuating side lobes are installed around each antenna.

Each array of FIG. 4A, B and C consists of 32 individual antennas, however this number is flexible. Different face curvature and angular positioning of each antenna in the arrays allows diverse target illumination occurring when each broadband antenna fires pulses at different times and directs them to a particular area. Depending upon the distance and size of the target in respect to the size of the array, different curvatures of the array have to be used. As such, if the size of the target corresponds to the size of the array the flat face array is used, while convex is used for small targets and concave for large. The 32-antenna concave array of FIG. 4A, where each antenna has a gain of approximately 20 dB allows reaching high field uniformity close to the breakdown E-field level at a distance of few antenna array diameters. One skilled in the art will understand that if higher E-fields, larger illumination area and longer duration time are required the number of antennas in the array could be increased. Furthermore, using geometrical scaling, the antenna arrays operating at different frequencies can be built.

FIG. 5A shows a cut-out view of broadband high power TEM-horn that is a copy of FIG. 2 in the U.S. Pat. No. 6,295,032 B1, which was issued Sep. 25, 2001 under the title “Broadband horn antennas and electromagnetic field test facility” and is assigned to the applicant of the present invention. FIG. 5B shows a cut-out view of the dielectric-loaded single-polarization high power broadband TEM-horn that is a copy of FIG. 1 in the U.S. Pat. No. 6,075,495, which was issued Jun. 13, 2000 under the title “Broadband TEM-horn antenna” assigned to the applicant of the present invention. These specific types of antennas used in the embodiments of this submission have high gain, bandwidth extending for at least one decade of frequencies, conical beam, no side lobes and high voltage capabilities. The high gain and conical beam are crucial for addition of power in the smallest possible area while the low side lobes are essential for closely spacing antennas in the array. FIG. 5A shows a TEM-horn antenna consisting of: horn 50, mouth of the horn 57, septum 53, one of two terminating resistors 100 ohm each 56, grounding the septum to the horn enclosure 50, EM absorbers 52 attenuating side lobes to prevent coupling between antennas and the main beam collimating lens 58. Use of a lens 58 increases the gain of the antenna however due to the additional weight the use of the lens is optional. In FIG. 5B a dielectric loaded TEM-horn antenna consisting of: horn 60, septum 63, counter-pose to the septum 64, two terminating resistors 100 ohm each 56, grounding the septum to the horn enclosure 60, and dielectric loading 65 consisting of two slabs joined along the surface 61 is presented. Two types of antenna inputs that can be used in this invention are shown: the coaxial 69 and stripline 67. The electromagnetic absorbers attenuating side lobes to prevent coupling between antennas are not shown. The purpose of using dielectric loading of the TEM-horn antenna is to increase the breakdown voltage between the septum 64 and the enclosure 60 and to reduce the volume of the horn antenna. Such reduction allows placing more TEM-horns in an antenna array without beam skewing, resulting in an increased output power. The total output power of the antenna array increases linearly with the increase of the dielectric constant εᵣ, i.e., the teflon εᵣ=2 loaded antenna will radiate power two time higher than if air loaded antenna having εᵣ=1 is used. FIG. 6, shows broadband, conical, double-polarization, multi-septum TEM-horn that is as the double-polarization antenna of FIG. 3A in the U.S. Pat. No. 6,075,495, issued Jun. 13, 2000 under the title “Broadband TEM-horn antenna” assigned to the applicant of the present invention except for four ground wedges inside the horn being removed. The removal of these wedges simplifies the assembly of vertical polarization septums 73 and 74, horizontal polarization septums 75 and 76, and it allows the insertion of high voltage insulating and supporting structures into the horn enclosure 70 without affecting the coupling between septums. The four 100 ohm terminating resistors 56 are connecting septums 73, 74, 75 and 76 to the horn enclosure 70. The embodiment of FIG. 6 shows transition 71 from four septums 73, 74, 75 and 76 that allows connecting four separate generators to the TEM-horn, resulting in increasing the output power four times. Furthermore, if a single septum antenna in the antenna array 13 of the Cassegrain antenna 40 of FIGS. 1 and 2 is replaced with the antenna of FIG. 6, the radiated E-field will be increased two times.

Alternatively, the four generators output power could be decreased four times to maintain the same output power as in the single septum antenna while the high voltage durability of this invention apparatus will be increased.

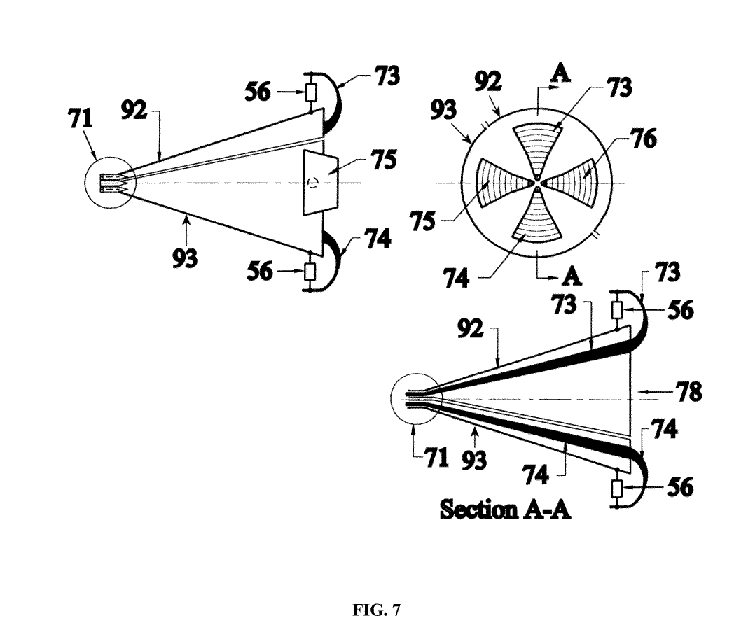

The embodiment of broadband, conical, double-polarization, multi-septum TEM-horn, bisected to form two enclosures is shown in FIG. 7. The antenna is identical to antenna of FIG. 6 however, the conical enclosure 70 in FIG. 6 is in FIG. 7 bisected to form two enclosures 92 and 93 separated from each other along the entire length of the antenna. This allows increasing the bandwidth by a factor of four while maintaining the power and high voltage durability seen in the embodiment of FIG. 6. The elements of FIG. 7 have numbers corresponding with numbers in FIG. 6.

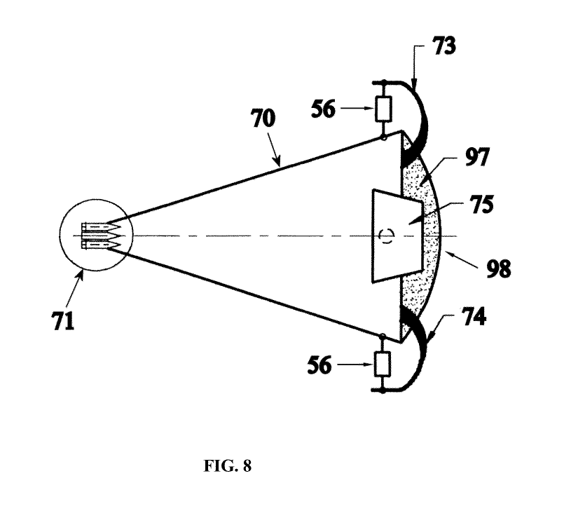

FIG. 8, shows broadband, conical, double-polarization, multi-septum TEM-horn loaded with dielectric 97 having coaxial antenna input connection 71. It should be understood by anyone who is skilled in the art, that the embodiment of FIG. 8 consisting of dielectric loading can be used in the antennas of FIGS. 6 and 7. Furthermore, if a single septum antenna in the antenna array 13 of the Cassegrain antenna 40 of FIGS. 1 and 2 is replaced with the antenna of FIG. 8, the generated power will be increased eight times for the antenna filled with dielectric having dielectric constant εᵣ=2 instead of air εᵣ=1. Having such increase in power allows balancing design of the Cassegrain antenna 40 and antenna array since even if the output power is increased four times instead of eight, the high voltage durability is still increased.

1-9. (canceled)

10. Method for combining broadband GW peak power to achieve MV/m and GV/m radiated E-field using many separate and independently triggered generators and spatially and angularly positioned TEM-horns adding individual pulses and beams to reach at a target or targets the maximum power density limited only by the E-field of air, vacuum and pressurized gas breakdown level, comprising the steps of:
concentrating spatially and in time at a single or multiple points radiated conical beams coming from multiple independently triggered pulse generators supplying power to multiple broadband TEM-horns;
optimizing timing of each generator triggering and the generated pulses spectral content to allow variation in the radiated E-field and energy delivered to the target or targets in the vicinity of breakdown and at optimal energy level causing either upset or destruction;
delivering broadband frequency spectral content in generated pulses to induce an oscillating response at specific resonance frequencies of target or targets;
prolonging the effects of the oscillating response to a pulse with duration defined by the minimum frequency of the target or targets bandwidth for a period proportional to the oscillation quality factor therefore reducing number of required excitation pulses and the energy from generators;
controlling the frequency range of operation through the geometrical scaling of apparatus and defining the maximum frequency of operation considering the molecular interactions that changes the electromagnetic properties of materials precluding functioning of the apparatus of this invention.

11. Apparatus for combining broadband GW peak power to achieve MV/m radiated E-field, comprising:
multiple independently triggered pulse generators configured to supply power to multiple broadband TEM-horns radiating conical beams focused at a single or multiple points in front of array;
each TEM-horn has a single or multiple septums and connected to each septum at the input of the TEM-horn is one of the independently triggered generator;
configuring the triggering sequence of individual generators allows reaching at a target or targets the maximum power density limited only by the E-field of air, vacuum and pressurized gas breakdown level.

12. The apparatus of claim 11 for collimating diverging conical beams of individual antennas into a single non-diverging beam:
multiple conical beams from the TEM-horns are configured to focus at a center of secondary reflector of a Cassegrain antenna and after being reflected from primary reflector are focused at infinity creating a single beam propagating without divergence up to a distance of square of the diameter of the primary reflector expressed in wavelengths;
using optimal number of the TEM-horns that is proportional to the square of primary reflector diameter expressed in wavelengths results in maximum peak power of the Cassegrain antenna.

13. The apparatus of claim 11 for collimating the diverging conical beams of individual antennas into a single non-diverging beam:
multiple conical beams from the TEM-horns are configured to generate multiple conical beams to focus at a center of Barlow lens system reducing the angle of illumination at a secondary reflector of a Cassegrain antenna;
the beams after being reflected from secondary and primary reflector create a single beam that is focused at infinity and propagates without divergence;
propagation through the Barlow lens system increases angular beam amplification in a Cassegrain antenna resulting in increasing distance of the beam propagation without divergence proportionally to the angular beam amplification.

14. Apparatus of combining broadband GW peak power to achieve GV/m radiated E-field comprising multiple Cassegrain antennas as in claim 12 and a focal lens or off the main axis focusing mirror that is configured to collimate the non-diverging beam coming from each Cassegrain antenna at a single point;
the apparatus functions as a high power apparatus for generating E-field close to and above breakdown needed for plasma interactions, but as well as wireless electromagnetic transmitter and receiver for control of molecular and atomic interactions.

15. Apparatus of combining broadband GW peak power to achieve GV/m radiated E-field comprising multiple Cassegrain antennas with Barlow lens system as in claim 13 and a focal lens or off the main axis focusing mirror that is configured to collimate the non-diverging beam coming from each Cassegrain antenna at a single point;
propagation through the Barlow lens system increases angular beam amplification in a Cassegrain antenna resulting in increasing distance of the beam propagation without divergence proportionally to the angular beam amplification reducing the beam divergence at the focal point.

16. Apparatus of broadband dielectrically loaded TEM-horn incorporated into the apparatus of claim 11 is configured to increase the power density of radiated beam proportionally to the dielectric constant of the dielectric material inserted into the TEM-horn.

17. Apparatus of broadband multi-septum TEM-horn incorporated into the apparatus of claim 11 is configured to increase the power of the radiated beam proportionally to the number of septum in the TEM-horn as each septum at the input of the TEM-horn is connected to an independently triggered generator.

18. Apparatus of broadband multi-septum TEM-horn with dielectric loading incorporated into the apparatus of claim 11 is configured to increase the power of the radiated beam proportionally to the number of septum in the TEM-horn as each septum at the input of the TEM-horn is connected to an independently triggered generator;
dielectric loading of the TEM-horn having a collimating lens profile at the TEM-horn mouth that focuses the radiating beam at infinity is increasing the power density of the radiated beam proportionally to the number of septum multiplied by the dielectric constant of the material inserted into the TEM-horn.

19. Apparatus of broadband multi-septum TEM-horn having an enclosure consisting of two parts separated from each other along the entire length of the TEM-horn incorporated into the apparatus of claim 11 is configured to increase the power of the radiated beam proportionally to the number of septum in the TEM-horn as each septum at the input of the TEM-horn is connected to an independently triggered generator;
the two part enclosure is configured to expand the bandwidth in respect to bandwidth of identical antennas having undivided enclosure.

20. Apparatus of broadband multi-septum TEM-horn with dielectric loading incorporated into the apparatus of claim 19 is configured to increase the power density of the radiated beam proportionally to the number of septum in the TEM-horn as each septum at the input of the TEM-horn is connected to an independently triggered generator:
the two parts enclosure is configured to expand the bandwidth in respect to bandwidth of identical TEM-horns having undivided enclosure;
dielectric loading of the TEM-horn having a collimating lens profile at the TEM-horn mouth focuses beam at infinity increasing the power density of the radiated beam proportionally to the number of septum multiplied by the dielectric constant of the material inserted into the TEM-horn.
